(19) United States
(12) Patent Application Publication
(10) Pub. No.: US 2022/0004791 A1
(43) Pub. Date: Jan. 6, 2022

(54) Method and Device for Biometric Authentication of Pulse Oximeter Readings

(71) Applicant: Liberty Health Technologies, Inc., Santa Barbara, CA (US)

(72) Inventor: Chris Outwater, Carpinteria, CA (US)

(21) Appl. No.: 17/367,390

(22) Filed: Jul. 4, 2021

Related U.S. Application Data
(60) Provisional application No. 63/047,982, filed on Jul. 3, 2020.

(51) Int. Cl. G06K 9/00

(52) U.S. Cl. CPC G06K 9/00885; G06K 9/0002; G06K 2009/00932; G06K 9/0004; G06K 9/00087

(57) ABSTRACT

Light is transmitted through a finger in order to illuminate a vein pattern using a first optical illuminator located in a top portion of a pulse oximeter housing. The pulse oximeter housing includes the top portion for contact with a top of the finger and a bottom portion for contact with a bottom of the finger. The vein pattern is detected using a first two-dimensional image detector positioned in the bottom portion, producing a vein pattern image. Similarly, a fingerprint of the finger is illuminated using a second source device in the bottom portion. The fingerprint is detected using a second two-dimensional image detector in the bottom portion, producing a fingerprint image. The vein pattern image and the fingerprint image are combined, producing a combined image. The combined image is compared to one or more other combined images to identify the finger.

### CROSS-REFERENCE TO RELATED APPLICATION

This application claims priority to U.S. Provisional Application No. 63/047,982, filed Jul. 3, 2021, the disclosure of which is incorporated by reference herein in its entirety.

### INTRODUCTION

The teachings herein relate to detecting the vein pattern of a finger for biometric authentication. More particularly the teachings herein relate to systems and methods for detecting the vein pattern and fingerprint of a finger using a pulse oximeter.

The systems and methods herein can be performed in conjunction with a processor, controller, or computer system, such as the computer system of FIG. 1.

### Vein Pattern Recognition Background

The hemoglobin in a person's blood contains oxygen when it is transported from the lungs to the tissues in the body by arteries. By the time that the blood flows back to the heart via different arteries, this oxygen has been released. Vein pattern recognition uses this difference between deoxidized and oxygenated hemoglobin. Deoxidized hemoglobin absorbs infrared light, making the vein pattern visible if a scanner is used to illuminate it with infrared light.

Illuminating the vein pattern in the fingers using near-infrared light makes it possible to discern this pattern, thanks to the deoxidized hemoglobin. FIG. 2 is an exemplary image 200 of the vein pattern of a finger upon which embodiments of the present invention may be implemented. In the case of a finger scan, such as FIG. 2, the surface area that is dealt with is small. That means, on the one hand, that this is a more compact technique than a palm vein pattern recognition, as the scanner is simply a smaller device. On the other hand, it is less user-friendly, as the finger has to be positioned more precisely on the scanner.

### Pulse Oximeter Background

The pulse oximeter makes use of another important property to calculate oxygen saturation. That is, oxyhemoglobin and deoxyhemoglobin absorb light of different wavelengths in a specific way.

Using two LEDs, one of red light at approximately 660 nm and another at infrared or near-infrared light approximately 940 nm, the pulse oximeter can measure and calculate the individual's blood oxygen level. This technology is well known in the medical device industry.

Unfortunately, it is possible that an individual might try to submit a false blood oxygen reading that indicates that the individual is healthy so that the individual could go to work, school, or an event or to freely travel. There is presently no method to identify whose finger is inserted into the pulse oximeter device.

As a result, additional systems and methods are needed for identifying a person from information detected in a pulse oximeter reading.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, upon which embodiments of the present teachings may be implemented.

FIG. 2 is an exemplary image of the vein pattern of a finger upon which embodiments of the present invention may be implemented.

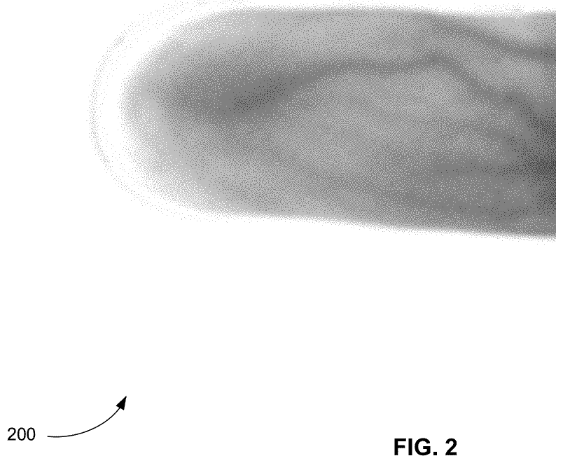

FIG. 3 is an exemplary diagram of a conventional pulse oximeter upon which embodiments of the present teachings may be implemented.

FIG. 4 is an exemplary diagram of a pulse oximeter that includes a two-dimensional image detector for detecting a vein pattern, in accordance with various embodiments.

FIG. 5 is an exemplary diagram showing a fingerprint image overlaid on top of a vein pattern image, in accordance with various embodiments.

FIG. 6 is a flowchart showing a computer-implemented method for detecting a vein pattern of a finger, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

Computer-Implemented System

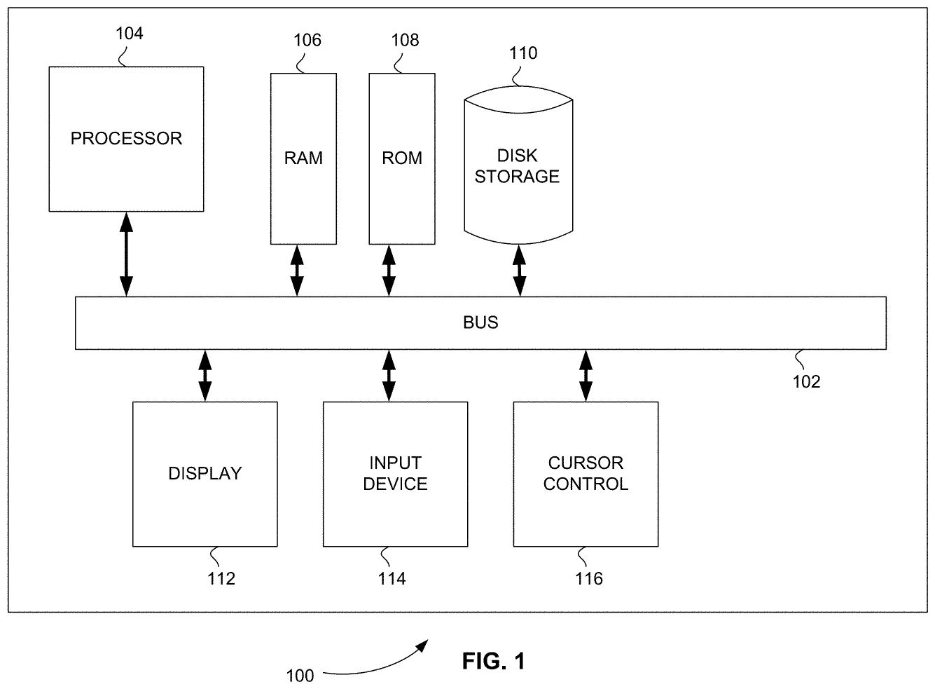

FIG. 1 is a block diagram that illustrates a computer system 100, upon which embodiments of the present teachings may be implemented. Computer system 100 includes a bus 102 or other communication mechanism for communicating information, and a processor 104 coupled with bus 102 for processing information. Computer system 100 also includes a memory 106, which can be a random-access memory (RAM) or other dynamic storage device, coupled to bus 102 for storing instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT) or liquid crystal display (LCD), for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively, hard-wired circuitry may be used in place of or in combination with software instructions to implement the present teachings. Thus, implementations of the present teachings are not limited to any specific combination of hardware circuitry and software.

The terms “computer-implemented method,” “computer-readable medium,” or “computer program product” as used herein refers to any media that participates in providing instructions to processor 104 for execution. The terms “computer-implemented method,” “computer-readable medium,” and “computer program product” are used interchangeably throughout this written description. Such a medium may take many forms, including but not limited to, non-volatile media, volatile media, and precursor ion mass selection media. Non-volatile media includes, for example, optical or magnetic disks, such as storage device 110. Volatile media includes dynamic memory, such as memory 106.

Common forms of computer-readable media include, for example, a floppy disk, a flexible disk, hard disk, magnetic tape, or any other magnetic medium, a CD-ROM, digital video disc (DVD), a Blu-ray Disc, any other optical medium, a thumb drive, a memory card, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

Oximeter Vein Pattern and/or Fingerprint Recognition

As described above, deoxidized hemoglobin absorbs infrared light, making the vein pattern visible if a scanner is used to illuminate it with infrared light. Illuminating the vein pattern in the fingers using near-infrared light makes it possible to discern this pattern, thanks to the deoxidized hemoglobin.

A pulse oximeter makes use of another important property to calculate oxygen saturation. That is, oxyhemoglobin and deoxyhemoglobin absorb light of different wavelengths in a specific way. Using two LEDs, one of red light at approximately 660 nm and another at infrared or near-infrared light approximately 940 nm, the pulse oximeter can measure and calculate the individual's blood oxygen level.

Unfortunately, it is possible that an individual might try to submit a false blood oxygen reading that indicates that the individual is healthy so that the individual could go to work, school, or an event or to freely travel. There is presently no method to identify whose finger is inserted into the pulse oximeter device.

As a result, additional systems and methods are needed for identifying a person from information detected in a pulse oximeter reading. In the growing field of telemedicine and the envisioned requirement for authenticated patient health data for documents such as health passports, the inventor envisions the need to tie the pulse oximeter reading to a simultaneous biometric reading of the individual's finger.

In various embodiments, a finger is identified when inserted into a pulse oximeter device by virtue of vein pattern recognition and/or fingerprint recognition. The confined area of a pulse oximeter device is well suited to the purpose of finger vein pattern and/or fingerprint recognition.

The vein pattern of a finger alone can be used to identify a person. In various embodiments, additional hardware can be added to a pulse oximeter to also obtain the fingerprint or unique pattern on the skin of a finger. The fingerprint or unique pattern can be used to verify the vein pattern.

Similarly, a fingerprint or unique pattern on the skin of a finger can be obtained by adding hardware to a pulse oximeter to alone identify a person. In various embodiments, the vein pattern of a finger can be obtained using the hardware of a pulse oximeter to verify the fingerprint or unique pattern on the skin of the finger. In other words, alone or in combination, the vein pattern and the fingerprint from a pulse oximeter can be used to identify a person.

In various embodiments, ultrasound fingerprint technology is included in the pulse oximeter. The ultrasound fingerprint sensor is placed directly under the sensor or imaging device that captures the light passing through the finger in the pulse oximeter. In another embodiment, the ultrasound fingerprint sensor is placed close to the light sensor or imaging device. In either case, the fingerprint can be captured during the pulse oximeter reading session. As with all biometric security systems, processing highly sensitive personal information security is key. The invention can incorporate processors with dedicated security tools, including Cryptographic Accelerators, Key Provisioning Security, and a Trusted Execution Environment. This ensures that the processing and storage of sensitive data are kept well away from malicious applications. Other Arm-based processors offer TrustZone hardware isolation for similar levels of protection.

In various embodiments, a biometric ID system. is designed to support the Fast Identity Online (FIDO) Alliance protocols, which are used for online password-less authentication. FIDO does this without transferring any of the confidential fingerprint information to the cloud or through networks that could be compromised.

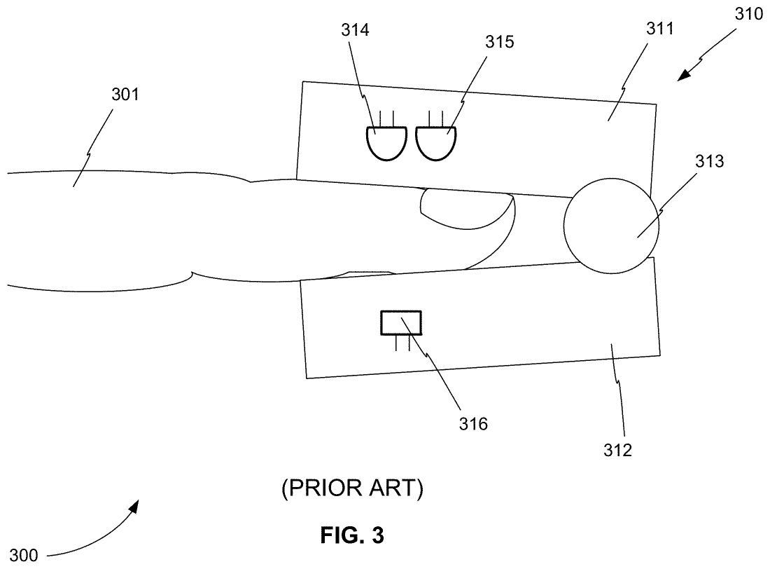

FIG. 3 is exemplary diagram 300 of a conventional pulse oximeter upon which embodiments of the present teachings may be implemented. In FIG. 3, finger 301 is held or squeezed between a top portion 311 and a bottom portion 312 of pulse oximeter housing 310. Hinge 313 of pulse oximeter housing 310 keeps top portion 311 and bottom portion 312 in contact with finger 301 and tends to flatten portions of finger 301.

As described above, a conventional pulse oximeter, like the one shown in FIG. 3, includes a first LED 314 in top portion 311 of red light at approximately 660 nm and a second LED 315 in top portion 311 of infrared or near-infrared light approximately 940 nm to illuminate finger 301. The transmission of these two wavelengths through finger 301 is detected using photodetector 316 in bottom portion 312, for example. Note that, although detection from transmission through finger 301 is shown in FIG. 3, one of ordinary skill in the art understands that a similar configuration can be used where the light detected is the light that is reflected from finger 301.

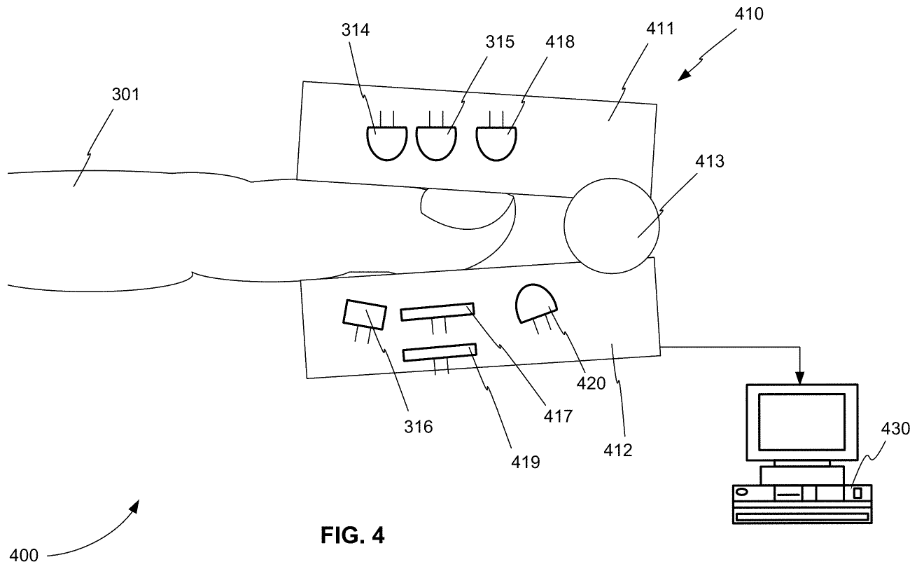

FIG. 4 is exemplary diagram 400 of a pulse oximeter that includes a two-dimensional image detector for detecting a vein pattern, in accordance with various embodiments. In FIG. 4, pulse oximeter 410 again includes a top portion 411, a bottom portion 412, and a hinge 413. Pulse oximeter 410 also includes a first LED 314 in top portion 411 of red light at approximately 660 nm and a second LED 315 in top portion 411 of infrared or near-infrared light approximately 940 nm to illuminate finger 301. The transmission of these two wavelengths through finger 301 is detected using photodetector 316 in bottom portion 412.

Now, however, bottom portion 412 further includes two-dimensional image detector 417, As described above, two-dimensional image detector 41 images the vein pattern in finger 301 illuminated by first LED 314 or second LED 315. In various alternative embodiments, top portion 411 can further dude a light source 418 that illuminates the vein pattern in figure 301 with a wavelength other than the wavelength of first LED 314 or second LED 315.

In various embodiments, bottom portion 412 further includes two-dimensional image detector 419 for detecting a fingerprint of finger 301. As described above, two-dimensional mage detector 419 can be an ultrasonic detector. For example, two-dimensional image detector 419 detects the sound waves from source 420 that are reflected from the fingerprint of finger 301.

In various alternative embodiments, two-dimensional image detector 419 is an optical image detector and source 402 produces light to illuminate the fingerprint of finger 301. Two-dimensional image detector 419 then detects the optical image reflected from the fingerprint of finger 301. Note that the light produced by source 430 does not penetrate the skin of finger 301 so than the image of the fingerprint can be obtained. Also, note that bottom potion 412 is designed to flatten the fingerprint area of finger 301 to produce a two-dimensional image of the fingerprint.

In various embodiments, bottom portion 412 includes at least two-dimensional image detector 417 for detecting the vein pattern, two-dimensional image detector 419 for detecting the fingerprint, and source 420 for illuminating the fingerprint. Using these devices, the vein pattern and the fingerprint are obtained for the same two-dimensional location. In other words, the vein pattern image in the fingerprint image can be easily overlaid without dimensional translation. This is particularly advantageous in that the fingerprint can be used to verify the vein pattern or the vein pattern can be used to verify the fingerprint. The flattening of the fingerprint by bottom portion 412 further ensures that two-dimensional images of both the vein pattern and the fingerprint are reproducible.

Note that one of ordinary skill in the art understands that a vein pattern is not limited to veins. In other words, the vein pattern can also include arteries.

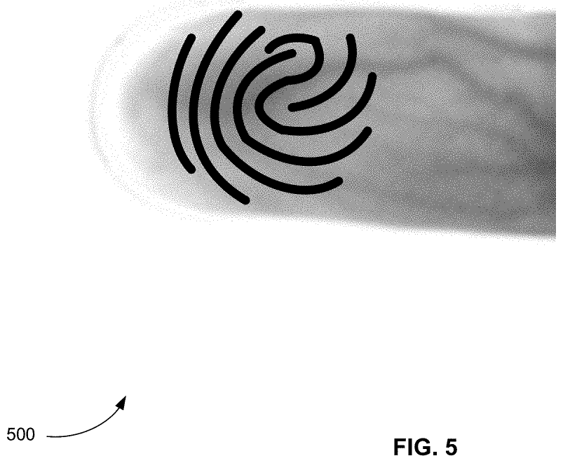

FIG. 5 is an exemplary diagram 500 showing a fingerprint image overlaid on top of a vein pattern image, in accordance with various embodiments. Fingerprint image 510 is overlaid on top of vein pattern image 520. These two images are, for example, obtained using two different detectors as described in FIG. 4. The images are then stored in a memory (not shown), for example, and are displayed together as shown in FIG. 5 using a processor and a display device. Note that, as shown in FIG. 5, now distances between fingerprint ridges and veins can be measured and compared. In other words, the fingerprint can verify the vein pattern and the vein pattern can verify the fingerprint. Heretofore, combined images from the same biometric device, such as a pulse oximeter were not previously thought possible.

System for Detecting a Vein Pattern

Returning to FIG. 4, a system for detecting a vein pattern includes pulse oximeter housing 410, first optical illuminator 314, and first two-dimensional image detector 417. Pulse oximeter housing 410 includes a top portion 411 for contact with a top of a finger 301 and a bottom portion 412 for contact with a bottom of finger 301.

First optical illuminator 314 is located in top portion 411. First optical illuminator 314 transmits light through finger 301 in order to illuminate a vein pattern of finger 301. First two-dimensional image detector 417 is positioned in bottom portion 412. First two-dimensional image detector 417 detects the vein pattern of finger 301, producing a vein pattern image.

As described above, some pulse oximeters detect reflected light rather than transmitted light. As a result, in various embodiments, first two-dimensional image detector 417 can be positioned in top portion along with first optical illuminator 314 in order to detect the vein pattern reflected from finger 301.

In various embodiments, first optical illuminator 314 can produce red or infrared light, for example. First optical illuminator 314 can be the same optical illuminator used to measure a pulse oxygen level. Alternatively, first optical illuminator 314 is a different optical illuminator from the optical illuminator used to measure a pulse oxygen level.

In various embodiments, the system further includes a memory device (not shown) and a processor 430. Processor 430 receives the vein pattern image from first two-dimensional image detector 417 and stores the vein pattern image in the memory device.

In various embodiments, processor 430 further compares the vein pattern image to one or more other vein pattern images in the memory device to identify finger 301.

In various embodiments, the system further includes a second source device 420 for illuminating a fingerprint of finger 301 in bottom portion 412 and second two-dimensional image detector 419 in bottom portion 412 for detecting the fingerprint, producing a fingerprint image.

As shown in FIG. 4, second two-dimensional image detector 419 in bottom portion 412 is added for detecting the fingerprint. As described above, second two-dimensional image detector 419 can be used without first two-dimensional image detector 417 allowing fingerprint detection without vein pattern detection.

In various embodiments, second source device 420 is a source of ultrasound, and second two-dimensional image detector 419 is an ultrasonic detector. In alternative embodiments, second source device 420 is a source of optical illumination and second two-dimensional image detector 419 is an optical detector.

In various embodiments, processor 430 further receives the fingerprint image from second two-dimensional image detector 419 and stores the fingerprint image in the memory device.

In various embodiments, processor 430 further compares the fingerprint image to one or more other fingerprint images in the memory device to identify finger 301.

In various embodiments, processor 430 further retrieves the vein pattern image for finger 301 from the memory device, retrieves the fingerprint image for finger 301 from the memory device, and combines the vein pattern image and the fingerprint image, producing a combined vein pattern and fingerprint image.

In various embodiments, processor 430 further compares the combined vein pattern and fingerprint image to one or more other combined vein pattern and fingerprint images in the memory device to identify finger 301.

In various embodiments, bottom portion 412 further flattens a fingerprint area of finger 301. In various embodiments, first two-dimensional image detector 417 is positioned to image the fingerprint area. In various embodiments, second two-dimensional image detector 419 is positioned to image the fingerprint area.

Method for Detecting a Vein Pattern

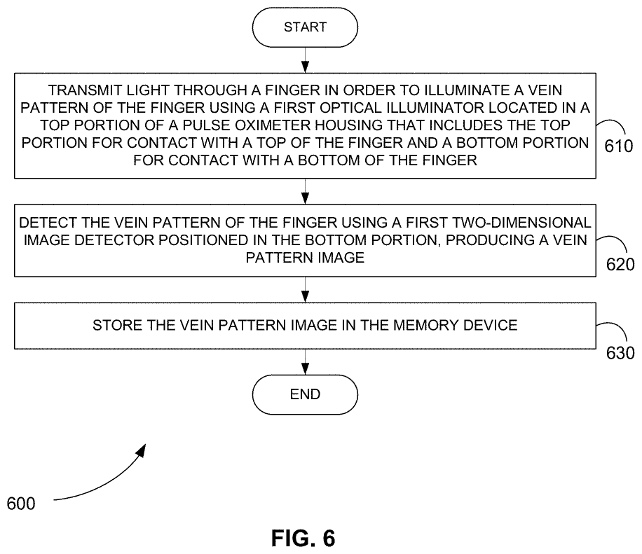

FIG. 6 is a flowchart showing a computer-implemented method for method 600 for detecting a vein pattern of a finger, in accordance with various embodiments.

In step 610 of method 600, light is transmitted through a finger in order to illuminate a vein pattern of the finger using a first optical illuminator located in a top portion of a pulse oximeter housing. The pulse oximeter housing includes the top portion for contact with a top of the finger and a bottom portion for contact with a bottom of the finger.

In step 620, the vein pattern of the finger is detected using a first two-dimensional image detector positioned in the bottom portion, producing a vein pattern image.

In step 630, the vein pattern image is stored in the memory device.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for detecting a vein pattern of a finger, comprising:
a pulse oximeter housing that includes a top portion for contact with a top of a finger and a bottom portion for contact with a bottom of the finger;
a first optical illuminator located in the top portion that transmits light through the finger in order to illuminate a vein pattern of the finger; and
a first two-dimensional image detector positioned in the bottom portion that detects the vein pattern of the finger, producing a vein pattern image.

2. The system of claim 1, wherein the first optical illuminator produces red light.

3. The system of claim 1, wherein the first optical illuminator produces infrared light.

4. The system of claim 1, wherein the first optical illuminator is the same optical illuminator used to measure a pulse oxygen level.

5. The system of claim 1, wherein the first optical illuminator is a different optical illuminator from the optical illuminator used to measure a pulse oxygen level.

6. The system of claim 1, further comprising a memory device and a processor that receives the vein pattern image from the first two-dimensional image detector and stores the vein pattern image in the memory device.

7. The system of claim 6, wherein the processor further compares the vein pattern image to one or more other vein pattern images in the memory device to identify the finger.

8. The system of claim 6, further comprising a second source device for illuminating a fingerprint of the finger in the bottom portion and a second two-dimensional image detector in the bottom portion for detecting the fingerprint, producing a fingerprint image.

9. The system of claim 8, wherein the second source device is a source of ultrasound and the second two-dimensional image detector is an ultrasonic detector.

10. The system of claim 8, wherein the second source device is a source of optical illumination and the second two-dimensional image detector is an optical detector.

11. The system of claim 8, wherein the processor further receives the fingerprint image from the second two-dimensional image detector and stores the fingerprint image in the memory device.

12. The system of claim 11, wherein the processor further compares the fingerprint image to one or more other fingerprint images in the memory device to identify the finger.

13. The system of claim 11, wherein the processor further retrieves the vein pattern image for the finger from the memory device, retrieves the fingerprint image for the finger from the memory device, and combines the vein pattern image and the fingerprint image, producing a combined vein pattern and fingerprint image.

14. The system of claim 13, wherein the processor further compares the combined vein pattern and fingerprint image to one or more other combined vein pattern and fingerprint images in the memory device to identify the finger.

15. The system of claim 8, wherein the bottom portion further flattens a fingerprint area of the finger.

16. The system of claim 15, wherein the first two-dimensional image detector is positioned to image the fingerprint area.

17. The system of claim 15, wherein the second two-dimensional image detector is positioned to image the fingerprint area.

18. A computer-implemented method for detecting a vein pattern of a finger, comprising:
transmitting light through a finger in order to illuminate a vein pattern of the finger using a first optical illuminator located in a top portion of a pulse oximeter housing that includes the top portion for contact with a top of the finger and a bottom portion for contact with a bottom of the finger;
detecting the vein pattern of the finger using a first two-dimensional image detector positioned in the bottom portion, producing a vein pattern image; and
stores the vein pattern image in the memory device.

19. The method of claim 18, further comprising
illuminating a fingerprint of the finger using a second source device in the bottom portion;
detecting the fingerprint using a second two-dimensional image detector in the bottom portion, producing a fingerprint image; and
storing the fingerprint image in the memory device.

20. The method of claim 19, further comprising
retrieving the fingerprint image for the finger from the memory device;
combining the vein pattern image and the fingerprint image, producing a combined vein pattern and fingerprint image; and
comparing the combined vein pattern and fingerprint image to one or more other combined vein pattern and fingerprint images in the memory device to identify the finger.
